(19) United States
(12) Patent Application Publication
(10) Pub. No.: US 2016/0185970 A1
(43) Pub. Date: Jun. 30, 2016

(54) Composition Comprising Disazo Dyes And Pigments

(71) Applicant: CLARIANT INTERNATIONAL LTD, Muttenz (CH)

(72) Inventors: Gerald ENGEL, Kelkheim (DE); Joachim EICHHORN, Frankfurt am Main (DE); Yvonne KAHLE, Klein-Winternheim (DE); Andreas ENDRES, Weißenhorn (DE); Marcus GIESLER, Rheinfelden (CH)

(73) Assignee: CLARIANT INTERNATIONAL LTD., Muttenz (CH)

(21) Appl. No.: 14/909,405

(22) PCT Filed: Jul. 28, 2014
(86) PCT No.: PCT/EP2014/002063

§ 371 Date: Feb. 1, 2016

(30) Foreign Application Priority Data
Aug. 1, 2013 (DE) 10 2013 012855.2

(51) Int. Cl. C09B 67/22; G02B 5/22; C09D 7/00; C09D 17/00; C09B 35/031; C09B 33/16

(52) U.S. Cl. CPC C09B 67/0041; C09B 35/031; C09B 33/16; C09D 7/007; C09D 17/003; G02B 5/223

(57) ABSTRACT

The invention relates to a colorant composition comprising at least one compound of the formula (I)

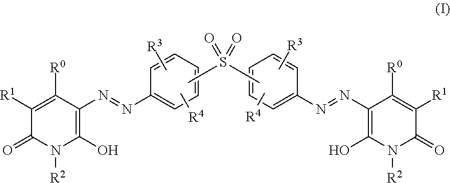

where
R⁰ is C₁-C₄ alkyl,
R¹ is H, C₁-C₄ alkyl, a sulfo group, —CO—NH—(C₁-C₄ alkyl), CN, or (C₁-C₄-alkylene)sulfo,
R² is H or C₁-C₄ alkyl,
R³ is H, a sulfo group, C₁-C₄ alkyl, or C₁-C₄ alkoxy,
R⁴ is H, C₁-C₄ alkyl, or C₁-C₄ alkoxy;
   and at least one organic pigment.

The colorant compositions are suitable especially for color filters.

The present invention relates to compositions comprising organic pigments and certain disazo dyes as used for example in color filters for liquid crystal displays or in OLED displays.

Liquid crystal displays (LCDs) are widely used in television sets, PC monitors, cell phones and tablet computers for example.

The functioning of LCDs is based on the following principle: Light shines first through one polarizer, then through a liquid crystal layer and subsequently through another polarizer. Under suitable electronic control and alignment by thin film transistors, the liquid crystals change the polarized light's direction of rotation, making it possible to control the brightness of the light emerging from the second polarizer and hence from the device.

Color filters are additionally incorporated in the arrangement between the polarizers in the case of colored LCD displays.

These color filters are typically situated on the surface of a transparent substrate, usually glass, and are applied there in the form of numerous uniformly arrayed pixels (picture elements) in primary colors, e.g., red, green, blue (R, G, B). A single pixel is from a few micrometers to 100 micrometers in size.

As well as the components mentioned, a liquid crystal display further comprises numerous other functional components such as thin film transistors (TFTs), alignment layers and others involved in controlling the liquid crystals and hence ultimately in picture creation.

If, then, light passes through the arrangement, the liquid crystals can be set to “bright” or “dark” (or to any stage in between)—separately for each pixel—by electronic control. The respectively assigned color filter pixels are correspondingly supplied with light and a human eye looking plan at the screen sees a corresponding colored, moving or fixed image based on R, G, B.

Different ways of arranging liquid crystals, electronic control elements and polarizers are known, for example twisted nematic (TN), super twisted nematic (STN), vertical alignment (VA) and in-plane switching (IPS).

The color filter pixels can further be arranged in different defined patterns for each primary color. Separate dots of the primary colors are arranged side by side and, illuminated from behind, produce a full color image. In addition to using the three primary colours red, green and blue, it is also known to use an additional color, for example yellow, to expand the color space or to use cyan, magenta and yellow as primaries.

In the case of OLED displays, color filters are likewise used in W-OLED displays. A white light is initially created in these displays from pixels of organic light emitting diodes, and subsequently split by use of color filters into individual colors, for example red, green and blue.

Color filters have to meet certain requirements: The manufacture of liquid crystal displays typically involves increased process temperatures of 230° C. during the steps of applying the transparent liquid crystal control electrode and the alignment layer. So the color filters used have to have high heat stability.

Further important requirements include, for example, a high contrast ratio, a high brightness for the color filter and the best possible hue.

A high contrast ratio has a positive effect on picture quality. Contrast ratio is measured by determining the intensity of light after passing through a color filter on a transparent substrate positioned between two polarizers. Contrast ratio is the ratio of the light intensities for parallel and perpendicular polarizers.

$$CR = \frac{light intensity ( parallel )}{light intensity ( perpendicular )}$$

A high level of transmission and the brightness resulting therefrom is desirable for the color filter because it means that less light has to be irradiated into the display to produce the same level of image brightness than in the case of a less bright color filter, allowing an overall energy saving.

Color filters typically use pigmented coatings. To produce such coatings, pigments are dispersed in an organic solvent in the presence of dispersing assistants and then admixed with suitable binders (acrylates, acrylic esters, polyimides, polyvinyl alcohols, epoxides, polyesters, melamines, gelatins, caseins) and with further auxiliaries to formulate a UV-curing light-sensitive varnish. This photoresist, so called, is applied as a thin layer atop the carrier substrate, patterned with UV light through masks and finally developed and heat treated. Multiple repetition of these steps for the individual primary colors creates the color filter in the form of a pixel pattern.

Dyes are also being increasingly used in color filters in order that contrast, brightness, hue and transmission may each be optimized to the stipulated purpose. However, commercially available dyes in particular usually lack fastness, in particular thermal stability.

Patent document JP S62-180302 (1986) describes the use for color filters of various acid dyes in the form of the free acid. However, the azo compounds recited therein exhibit insufficient stability to heat. Nor is working with free acids in keeping with best workplace health and safety practice.

Color filter colorants have to meet ever increasing demands.

Even commercially available products do not always meet all technical requirements. More particularly, there is a need for improvement with regard to heat stability, contrast and brightness on the part of the colorants used, without adverse effect on chroma and hue, and also with regard to dispersibility.

The problem addressed by the present invention was that of providing greenish yellow colorant compositions of good heat stability for color filter applications.

Surprisingly it has now been found that compositions comprising organic pigments and dyes of the general formula (I) are highly suitable for use in color filters. In compositions of organic pigments, the compounds of the formula (I) improve the dispersibility of the pigments and permit hue adjustment. They lead, consequently, to advantageous performance properties such as reduced dispersion viscosity and also enhanced color filter brightness and higher color filter contrast.

The invention provides colorant compositions comprising at least one compound of the formula (I)

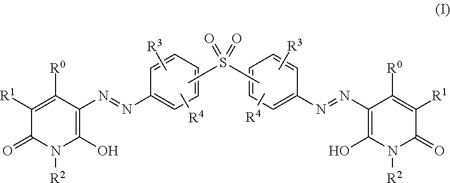

where
R⁰ is C₁-C₄ alkyl,
R¹ is H, C₁-C₄ alkyl, a sulfo group, —CO—NH—(C₁-C₄ alkyl), CN or (C₁-C₄ alkylene)sulfo,
R² is H or C₁-C₄ alkyl,
R³ is H, a sulfo group, C₁-C₄ alkyl or C₁-C₄ alkoxy,
R⁴ is H, C₁-C₄ alkyl or C₁-C₄ alkoxy;

and at least one organic pigment.

The compounds of the formula (I) preferably contain at least one sulfo group and more preferably contain two sulfo groups.

Preferably, R⁰ is C₁-C₂ alkyl, in particular methyl.

Preferably, R¹ is (C₁-C₄ alkylene)sulfo, in particular —CH₂-sulfo.

Preferably, R² is C₁-C₂ alkyl, in particular ethyl.

Preferably, R³ is H, a sulfo group, methyl or methoxy, in particular H.

Preferably, R⁴ is H, methyl or methoxy, in particular H.

Preferably, the position of the SO₂ bridge relative to the —N═N— groups is meta or para.

In particularly preferred compounds of the formula (I)

R⁰ is methyl,

R¹ is —CH₂-sulfo,

R² is ethyl,

R³ is H, a sulfo group, methyl or methoxy, in particular H, and

R⁴ is H, methyl or methoxy, in particular H.

Very particular preference is given to compounds of the formula (Ia)

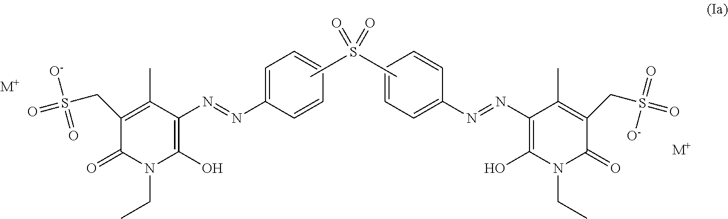

where M⁺ represents monovalent metal cations such as Li⁺, Na⁺ or K⁺ and also H, in particular Na⁺.

Preferably, the position of the SO₂ bridge relative to the —N═N— groups is meta or para, in particular para.

The compounds of formula (I) are known as such and are described in WO 2010/000779 A1 as textile dyes for dyeing or printing fibrous material consisting of natural or synthetic polyamides in aqueous media only.

Examples of pigments employable for the compositions of the invention include the following: anthraquinone pigments, laked or unlaked azo pigments, anthanthrone pigments, benzimidazolone pigments, quinacridone pigments, quinophthalone pigments, diketopyrrolopyrrole pigments, dioxazine pigments, disazo condensation pigments, isoindolinone pigments, isoindoline pigments, metal complex pigments, perinone pigments, perylene pigments, phthalocyanine pigments, and triarylcarbonium pigments.

Preferred yellow pigments are C.I. Pigment Yellow 138, 139, 150, 151, 155, 180, 213 and 214. Particularly preferred are C.I. Pigment Yellow 138, 139 or 150. Preferred red pigments are C.I. Pigment Red 122, 149, 166, 168, 177, 242, 254, 264, more preferably PR 254, PR 264, PR 242 or PR 177.

Also preferred are C.I. Pigment Orange 34, 36, 38, 43, 62, 64, 68, 71, 72, 73, 74, and 81.

Preferred green pigments are C.I. Pigment Green 7, 36 and 58.

In the blue and violet range, preference is given to C.I. Pigment Blue 15:6, 15:3, 15:2, 15:1 and 15, Pigment Blue 80, and C.I. Pigment Violet 19 and 23. Particularly preferred are Pigment Blue 15:6 and Pigment Blue 80.

The mixing ratios of compound of the formula (I) to organic pigment may in principle be from 1 to 99:99 to 1. In order to obtain particular coloristic properties, the proportion between compound of the formula (I) and pigment may vary within wide ranges, as for example from 5 to 95:95 to 5, preferably 10 to 90:90 to 10, more preferably from 20 to 80:80 to 20, very preferably 30 to 70:70 to 30, more particularly 40 to 60:60 to 40 parts by weight.

Where the compound of the formula (I) is to be used primarily as a dispersing improver for the pigment, it is also possible that smaller amounts may be sufficient, such as, for example, 1 to 20 wt %, preferably 2 to 10 wt %, of compound of the formula (I), based on the overall weight of the colorant composition.

Where the colorant compositions of the invention are in powder form, they may be used for other applications as well as for color filters. The colorant compositions of the invention may be employed in principle for pigmenting all high molecular mass organic materials of natural or synthetic origin, examples being plastics, resins, varnishes, especially metallic varnishes, paints, electrophotographic toners and developers, electret materials, and also liquid inks, printing inks, and seed.

The colorant compositions of the invention are suitable with particular preference as colorants for color filters both for additive and for substractive color generation, as for example in electrooptical systems such as LCDs (liquid crystal displays), OLED displays, charge coupled devices, plasma displays or electroluminescent displays, which in turn may be active (twisted nematic) or passive (supertwisted nematic) ferroelectric displays or light-emitting diodes, and also as colorants for electronic inks (e-inks) or electronic paper (e-paper).

Examples of high molecular mass organic materials which may be pigmented using the colorant compositions of the invention include cellulose compounds, such as, for example, cellulose ethers and cellulose esters, such as ethyl cellulose, nitrocellulose, cellulose acetates or cellulose butyrates, natural binders such as, for example, fatty acids, fatty oils, resins and their conversion products, or synthetic resins, such as polycondensates, polyadducts, step-growth addition polymers and copolymers, such as, for example, aminoplast resins, more particularly urea- and melamine-formaldehyde resins, alkyd resins, acrylic resins, phenoplast resins and phenolic resins, such as novolaks or resoles, urea resins, polyvinyls, such as polyvinyl alcohols, polyvinyl acetals, polyvinyl acetates or polyvinyl ethers, polycarbonates, polyolefins, such as polystyrene, polyvinyl chloride, polyethylene or polypropylene, styrene-butadiene copolymers, poly(meth)acrylates, and their copolymers, such as polyacrylic esters, styrene acrylates, or polyacrylonitriles, polyamides, polyesters, polyurethanes, polysulfones, coumarone-indene and hydrocarbon resins, epoxy resins, phenolic-epoxy resins, unsaturated synthetic resins (polyesters, acrylates) with the various curing mechanisms, waxes, aldehyde resins and ketone resins, vulcanized rubber, unvulcanized rubber and derivatives and latices thereof, casein, silicones and silicone resins, individually or in mixtures. It is immaterial here whether the aforementioned high molecular mass organic materials are present in the form of plastic masses, of melts or of spinning solutions, dispersions, varnishes, paints, or printing inks. Depending on the intended use, it proves advantageous to utilize the colorant compositions of the invention in the form of a blend or of preparations or dispersions.

It is also possible to prepare the colorant composition only in the course of incorporation into the high molecular mass organic medium.

The invention accordingly likewise provides a high molecular mass organic medium comprising a coloringly effective amount of a colorant composition of the invention.

Relative to the high molecular mass organic material to be colored, the substances of the invention are used generally in an amount of 0.01 to 45 wt %, preferably 0.1 to 40 wt %. In the case of use in color filters, higher amounts may also be employed.

The colorant compositions of the invention are also suitable as colorants in electrophotographic toners and developers, such as one- or two-component powder toners, magnetic toners, liquid toners, polymerization toners, and specialty toners, for example.

Furthermore, the colorant compositions of the invention are suitable as colorants in powders and powder coating materials, more particularly in triboelectrically or electrokinetically sprayable powder coating materials, which are employed to coat the surfaces of articles made from, for example, metal, wood, plastic, glass, ceramic, concrete, textile material, paper, or rubber.

The colorant compositions of the invention are suitable, moreover, as colorants in water-based and nonaqueous inkjet inks and also in inks which operate according to the hotmelt method.

Depending on the application, the colorant composition of the invention may also comprise further customary auxiliaries or adjuvants, such as, for example, surfactants, dispersants, rheology control additives, fillers, standardizers, resins, waxes, defoamers, antidust agents, extenders, antistats, charge control agents, preservatives, drying retarders, wetting agents, antioxidants, UV absorbers, light stabilizers, and binders, as for example the binders of the system in which the composition of the invention is to be employed. When present, the auxiliaries and adjuvants are used preferably in an amount of 0.01 to 15 wt %, more particularly 0.5 to 10 wt %, based on the total weight of the pigment composition.

For color filters more particularly, the composition of the invention may also comprise surfactants, dispersants, resins and waxes, for example.

The colorant compositions of the invention composed of pigment and dye of the formula (I) may also take the form of a millbase or of a bindered colorant dispersion (photoresist).

The present invention accordingly also provides a millbase containing 0.01 to 45 wt %, preferably 2 to 20 wt % and especially 7 to 17 wt % of the colorant composition composed of compounds of the formula (I) and organic pigment, in the form of a dispersion in an organic solvent.

Useful organic solvents include for example:

ethyl lactate, benzyl alcohol, 1,2,3-trichloropropane, 1,3-butanediol, 1,3-butylene glycol, 1,3-butylene glycol diacetate, 1,4-dioxane, 2-heptanone, 2-methyl-1,3-propanediol, 3,5,5-trimethyl-2-cyclohexen-1-one, 3,3,5-trimethylcyclohexanone, 3-ethoxyethylpropionate, 3-methyl-1,3-butanediol, 3-methoxy-3-methyl-1-butanol, 3-methoxy-3-methylbutyl acetate, 3-methoxybutanol, 3-methoxybutyl acetate, 4-heptanone, m-xylene, m-diethylbenzene, m-dichlorobenzene, N,N-dimethylacetamide, N,N-dimethylformamide, n-butyl alcohol, n-butylbenzene, n-propyl acetate, o-xylene, o-chlorotoluene, o-diethylbenzene, o-dichlorobenzene, p-chlorotoluene, p-diethylbenzene, sec-butylbenzene, tert-butylbenzene, gamma-butyrolactone, isobutyl alcohol, isophorone, ethylene glycol diethyl ether, ethylene glycol dibutyl ether, ethylene glycol monoisopropyl ether, ethylene glycol monoethyl ether, ethylene glycol monoethyl ether acetate, ethylene glycol mono-tert-butyl ether, ethylene glycol monobutyl ether, ethylene glycol monobutyl ether acetate, ethylene glycol monopropyl ether, ethylene glycol monohexyl ether, ethylene glycol monomethyl ether, ethylene glycol monomethyl ether acetates, diisobutylketone, diethylene glycol diethyl ether, diethylene glycol dimethyl ether, diethylene glycol monoisopropyl ether, diethylene glycol monoethyl ether acetate, diethylene glycol monobutyl ether, diethylene glycol monobutyl ether acetate, diethylene glycol monomethyl ether, cyclohexanol, cyclohexanol acetate, cyclohexanone, dipropylene glycol methyl ether, dipropylene glycol methyl ether acetate, dipropylene glycol monoethyl ether, dipropylene glycol monobutyl ether, dipropylene glycol monopropyl ether, dipropylene glycol monomethyl ether, diacetone alcohol, triacetylglycerol, tripropylene glycol monobutyl ether, tripropylene glycol monomethyl ether, propylene glycol diacetate, propylene glycol phenyl ether, propylene glycol monoethyl ether, propylene glycol monoethyl ether acetates, propylene glycol monobutyl ether, propylene glycol monopropyl ether, propylene glycol monomethyl ether, propylene glycol monomethyl ether acetate, propylene glycol monomethyl ether propionates, benzyl alcohol, methyl isobutyl ketone, methylcyclohexanol, n-amyl acetate, n-butyl acetate, isoamyl acetate, isobutyl acetate, propyl acetates, dibasic ester (DBE).

Of particular advantage are ethyl lactate, propylene glycol monomethyl ether acetate (methoxypropyl acetate), propylene glycol monoethyl ether acetate, ethylene glycol monomethyl ether acetate, ketones such as cyclohexanone or alcohols such as n-butanol or benzyl alcohol.

The organic solvents can be used alone or mixed with one another.

The millbase of the present invention may also contain dispersing assistants.

Useful dispersing assistants include commonly known compounds, for example polymeric dispersing assistants. These are typically polymers or copolymers based on polyesters, polyacrylates, polyurethanes and also polyamides. Wetting agents may further be used, examples being anionic or nonionic wetting agents. The recited wetting agents and dispersing assistants can be used individually or in combination. Their amount is advantageously from 2 to 100 wt %, preferably from 10 to 50 wt %, based on the total weight of the colorant composition.

To produce the millbases, the colorant composition of the invention is subjected to a dispersing operation, in which case typical dispersing apparatus may be used.

When the colorant composition of the invention is used in the form of a dispersed colorant in a millbase, a small primary particle size is advantageously first set in a suitable manner. Particularly suitable primary particle sizes are less than 60 nm and preferably less than 40 nm in the d₅₀ value. It is similarly advantageous to set a narrow particle size distribution.

The particle size distribution after comminution preferably approximates a Gaussian distribution in which the standard deviation sigma is preferably less than 30 nm and more preferably less than 20 nm. The standard deviations are generally between 5 and 30 nm, preferably between 6 and 25 nm and particularly between 7 and 20 nm.

The standard deviation sigma (σ) corresponds to the positive square root of the variance. The variance v is the sum total of the squared deviations from the mean, divided by the number of samples minus 1. It is further advantageous for the d95 value of the comminuted particles to be not more than 70 nm. The length to width ratio of the comminuted particles is preferably between 2:1 and 1:1.

One way to achieve the fine state of subdivision is salt kneading with a crystalline inorganic salt in the presence of an organic solvent. Useful crystalline inorganic salts include, for example, aluminum sulfate, sodium sulfate, calcium chloride, potassium chloride or sodium chloride, preferably sodium sulfate, sodium chloride and potassium chloride. Useful organic solvents include, for example, ketones, esters, amides, sulfones, sulfoxides, nitro compounds, mono-, bis- or tris-hydroxy-C₂-C₁₂-alkanes which may be substituted with C₁-C₈ alkyl and with one or more hydroxyl groups. Particular preference is given to water-miscible high-boiling organic solvents based on monomeric, oligomeric, and polymeric C₂-C₃ alkylene glycols, e.g., diethylene glycol, diethylene glycol monomethyl ether, diethylene glycol monoethyl ether, triethylene glycol, triethylene glycol monomethyl ether, triethylene glycol monoethyl ether, dipropylene glycol, dipropylene glycol monomethyl ether, dipropylene glycol monoethyl ether, propylene glycol monomethyl ether, propylene glycol monoethyl ether and liquid polyethylene glycols and polypropylene glycols, N-methylpyrrolidone and also triacetin, dimethylformamide, dimethylacetamide, ethyl methyl ketone, cyclohexanone, diacetone alcohol, butyl acetate, nitromethane, dimethyl sulfoxide and sulfolane.

The weight ratio between the inorganic salt and the compound of formula (I) is preferably (2 to 10):1 and particularly (3 to 7):1. The weight ratio between the organic solvent and the inorganic salt is preferably 1 ml:10 g to 2 ml:7 g. The weight ratio between the organic solvent and the sum of inorganic salt and the colorant composition of the invention is preferably 1 ml:2 g to 1 ml:10 g.

The temperature during kneading may be between 40 and 140° C., preferably 60 to 120° C. Kneading time is advantageously from 4 h to 32 h, preferably from 8 h to 20 h.

After salt kneading, the inorganic salt and the organic solvent are advantageously removed by washing with water and the comminuted colorants thus obtained are dried by conventional methods.

The material obtained following the conversion into a fine state of subdivision may optionally be subjected in the form of a suspension, filter cake or dry material to a solvent aftertreatment (finishing treatment) in order to obtain a more homogeneous particle shape without marked increase in the particle size. Preference is given to using steam-volatile solvents such as alcohols and aromatic solvents, more preferably branched or unbranched C₁-C₆ alcohols, toluene, xylene, chlorobenzene, dichlorobenzene, nitrotoluene or nitrobenzene usually under elevated temperature, for example at up to 200° C., and optionally under elevated pressure.

The invention further provides a bindered colorant dispersion containing 0.01 to 40 wt %, preferably 0.1 to 30 wt %, particularly 1 to 20 wt %, of colorant composition of the invention in the form of a dispersion in at least one organic solvent, at least one polymeric binder and optionally further auxiliaries.

The bindered colorant dispersion is advantageously prepared by mixing the above-described millbase with the other components mentioned.

Useful polymeric binders include, for example, acrylates, acrylic esters, polyimides, polyvinyl alcohols, epoxides, polyesters, melamines, gelatins, caseins and polymerizable ethylenically unsaturated monomers and oligomers, preferably those which crosslink either thermally or under the effect of UV light and radical initiators. The amount of polymeric binders is advantageously from 5 to 90 wt % and preferably from 20 to 70 wt % based on the total amount of all nonvolatile constituents of the colorant dispersion. Nonvolatile constituents are the compounds of formula (I), the organic pigments, the polymeric binders and the further auxiliaries. Volatile constituents are the organic solvents which are volatile under the baking temperatures used.

Useful organic solvents include the solvents mentioned above for the millbase. They are advantageously present in an amount of from 10 to 90 wt %, preferably from 20 to 80 wt %, based on the overall amount of the colorant dispersion.

Useful further auxiliaries include, for example, crosslinkers and radical initiators, flow control agents, defoamers and deaerators. They are advantageously present in an amount of from 0 to 10 wt %, preferably from 0 to 5 wt %, based on the overall amount of the colorant dispersion.

When further auxiliaries are used, a lower limit of 0.01 wt %, preferably 0.1 wt %, is advantageous, based on the overall amount of the colorant dispersion.

It was surprising that a combination of the compounds of the formula (I), known as dyes for textiles, with organic pigments exhibits good properties, particularly good dispersibility, high contrast, improved brightness and good heat stability, for use in color filters.

EP 1944339 A2 describes combinations of organic pigments with azo compounds containing sulfonic acid, useful in applications including color filters. But the azo compounds described are structurally different from the compounds (I) employed here. They are on the one hand reddish Naphtol AS derivatives, whose hue differs markedly from the greenish yellow range, leading to a strong shift in the desired coloristic properties, particularly in combination with yellow and green pigments. On the other hand, the patent describes monoazo yellow pigment derivatives derived from acetanilides. The skilled person knows such yellow monoazo compounds to possess generally poor fastness qualities such as temperature stability, recrystallization stability and lightfastness, this being a disadvantage for application in color filters.

The present invention also provides a method for producing the compositions of the invention, which comprises combining with one another the compounds of the formula (I) and the organic pigments. Advantageously, optionally following reduction of the primary particle size, the components are combined in a dispersing step or are combined by mixing a solution or dispersion of compounds of the formula (I) with a dispersion of the pigment.

The respective components may be used in a dry form, such as in granule or powder form, or in a wet form, such as in presscake form, for example.

Preference is given to their combination during a reduction in the primary particle size. That operation serves to produce smaller particle sizes, narrower particle size distributions and, consequently, to further optimize the performance properties particularly for color filters.

The reduction in the primary particle size may be accomplished by wet or dry grinding, but preferably by salt kneading with a crystalline inorganic salt in the presence of an organic solvent, as described above.

The yellow hues of the colorant compositions of the invention are very particularly highly suited to the color filter color set red-green-blue (R, G, B). These three colors are present side by side as discrete colored dots and produce a full color picture on illumination from behind. There are also color filter systems which operate with four primary colors, red-green-blue and yellow (R, G, B, Y), for which the colorant compositions of the invention are likewise well suited.

The invention further provides the use of the above-described colorant composition in color filters, both in the form of the millbase described or in the form of bindered colorant dispersion.

The concentration at which the colorant compositions of the invention are used in the applied color filter film may be between 5 and 95 wt %, preferably between 20 and 80 wt %, very preferably between 30 and 50 wt %, based on the overall weight of the color filter film.

The invention also provides a color filter comprising a coloringly effective amount of the colorant composition of the invention.

In the examples which follow, percentages are by weight and parts are by weight, unless otherwise indicated.

### EXAMPLE 1

### Composition 1

2.0 g of the compound (II) prepared as in Example 2 of WO2010000779 A1 are ground with 18.0 g of C.I. Pigment Yellow 138 in an IKA laboratory powder mill. Following discharge from the mill, 19.5 g of the inventive composition 1 are obtained, in the form of a greenish yellow powder.

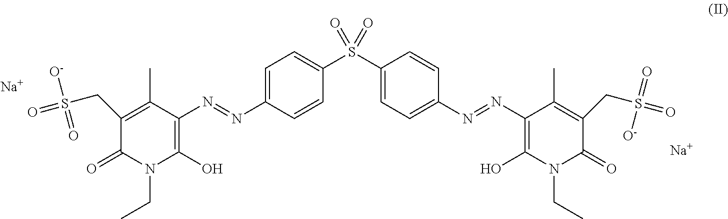 [SMILES: [Na+] ; CCn1c(O)c(/N=N/c2ccc(S(=O)(=O)c3ccc(/N=N/c4c(C)c(CS(=O)(=O)[O-])c(=O)n(CC)c4O)cc3)cc2)c(C)c(CS(=O)(=O)[O-])c1=O ; [Na+]]

### EXAMPLES 2 to 8

In the same way as for Example 1, the pigments listed in the table below are used in place of the C.I. Pigment Yellow 138. The products in each case are the inventive compositions 2 to 8.

| Example | Pigment |
|---|---|
| 2 | C.I. Pigment Yellow 150 |
| 3 | C.I. Pigment Yellow 139 |
| 4 | C.I. Pigment Green 36 |
| 5 | C.I. Pigment Green 58 |
| 6 | C.I. Pigment Red 254 |
| 7 | DPP pigment as per Example 1 in WO2009/049736A1 |
| 8 | C.I. Pigment Red 242 |

Color Filter Performance Testing:

Use Example 1:

10.0 g of the composition prepared as described in Example 1 are dispersed in a paint shaker beaker with 72.5 g of methoxypropyl acetate (PGMEA), 5.0 g of n-butanol and also 12.5 g of Disperbyk® 2001 (BYK-Chemie, polymeric dispersing assistant solution) by stirring. An addition of 250 g of zirconium oxide beads (0.3 mm) is followed by dispersal in a dispersing device from Lau (Dispermat) for three hours. The millbase obtained is separated from the beads by filtration. The millbase viscosity is measured (Haake RheoStress 1 rotational viscometer, plate/cone measuring geometry, 23° C., linear increase in shear rate D to 250 1/s, determination of value at 250 1/s.).

20.0 g of this millbase are mixed with 20.5 g of a 10 wt % solution of Joncryl® 611 (styrene-acrylate resin, BASF AG) in PGMEA by shaking for 10 minutes without beads. The dispersion is then filtered.

The bindered colorant dispersion obtained is applied by means of a spincoater (POLOS Wafer Spinner) atop glass plates (SCHOTT, laser cut, 10×10 cm) in a layer thickness such that when illuminant C is used, the color coordinates y in table 2a and/or color coordinates x in table 2b can be set as reference values.

This layer thickness is in each case approximately 1 to 2 micrometers.

The glass plates were allowed to flash off and then dried for 10 min at 80° C. in a circulating air drying cabinet (from Binder). The glass plates are measured for the prebake values of the color coordinates (x, y, Y, and also CIELAB, Datacolor 650 spectrophotometer, illuminant C, 2° observer), transmission curves (ditto) and contrast values (Tsubosaka CT-1 contrast tester). The glass plates are subsequently subjected to a heat treatment at 250° C. for 1 h in the circulating air drying cabinet and remeasured to obtain the postbake values.

### Comparative Examples: C1-C11

The millbases and color dispersions are prepared in the same way as in the case of Use Example 1. However, rather than pigment compositions of the invention, the parent base pigments are used.

Tables 2a and 2b show the results for the inventive examples and for the comparative examples in postbake.

The relative contrast ratio CR relates to the color dispersion of the respective comparative example (100%).

The values x, y and Y identify the measured color coordinates in the CIE-Yxy standardized color space, where Y is a measure of the brightness.

A comparison was made in each case of the inventive composition with the associated base pigment. For the contrast value, the contrast value of the base pigment in the comparative example was set at 100% in each case. For the comparison of the brightnesses Y, the difference example Yₑₓₐₘₚₗₑ-Y_{comparative example} was formed in each case. If this value is >0, then the brightness of the inventive sample is greater than that of the comparative example.

For the comparison of the viscosities, the viscosity of the comparative example was set at 100% in each case.

TABLE 2a
(reference to y values)

| | | Rel. | | | | Rel. |
|---|---|---|---|---|---|---|
| | | viscosity of | | | | contrast |
| | | millbase | y = | | Rel. Y | value |
| Ex. | Description | [%] | (Ref.) | x = | value | [%] |
| 1 | Composition 1 | 71 | 0.500 | 0.430 | +6.9 | 247 |
| C1 | C.I. Pigment | 100 | 0.500 | 0.439 | 0 | 100 |
| | Yellow 138 | | | | | |
| 2 | Composition 2 | 93 | 0.500 | 0.422 | +0.9 | 105 |
| C2 | C.I. Pigment | 100 | 0.500 | 0.425 | 0 | 100 |
| | Yellow 150 | | | | | |
| 3 | Composition 3 | 78 | 0.500 | 0.485 | +1.0 | 110 |
| C3 | C.I. Pigment | 100 | 0.500 | 0.485 | 0 | 100 |
| | Yellow 139 | | | | | |
| 4 | Composition 4 | 86 | 0.440 | 0.274 | +8.3 | 104 |
| C4 | C.I. Pigment | 100 | 0.440 | 0.240 | 0 | 100 |
| | Green 36 | | | | | |
| 5 | Composition 5 | 78 | 0.500 | 0.285 | +5.2 | 105 |
| C5 | C.I. Pigment | 100 | 0.500 | 0.260 | 0 | 100 |
| | Green 58 | | | | | |

TABLE 2b
(reference to x values)

| | | Rel. | | | | Rel. |
|---|---|---|---|---|---|---|
| | | viscosity of | | | | contrast |
| | | millbase | | x = | Rel. Y | value |
| Ex. | Description | [%] | y = | (Ref.) | value | [%] |
| 6 | Composition 6 | 8 | 0.324 | 0.650 | +3.0 | 186 |
| C6 | C.I. Pigment | 100 | 0.312 | 0.650 | 0 | 100 |
| | Red 254 | | | | | |
| 7 | Composition 7 | 11 | 0.333 | 0.650 | +2.1 | 143 |
| C7 | DPP pigment as per | 100 | 0.324 | 0.650 | 0 | 100 |
| | Example 1 from | | | | | |
| | WO2009/049736A1 | | | | | |
| 8 | Composition 8 | 86 | 0.380 | 0.600 | +3.0 | 118 |
| C8 | C.I. Pigment | 100 | 0.364 | 0.600 | 0 | 100 |
| | Red 242 | | | | | |

### EXAMPLE 9

The procedure of Example 1 is repeated, but using, rather than the compound (II), the compound (3), prepared according to Example 1 from WO2010000779 A1:

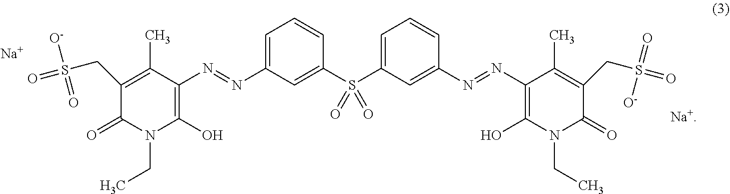

Preparation of the millbase and of the colorant dispersion, and also performance testing, take place in the same way as for Example 1.

| | | Rel. | | | | Rel. |
|---|---|---|---|---|---|---|
| | | viscosity of | | | | contrast |
| | | millbase | y = | | Rel. Y | value |
| Ex. | Description | [%] | (Ref.) | x = | value | [%] |
| 9 | Composition 9 | 82 | 0.500 | 0.428 | +5.8 | 208 |
| C9 | C.I. Pigment | 100 | 0.500 | 0.439 | 0 | 100 |
| | Yellow 138 | | | | | |

### EXAMPLE 10

An aqueous suspension of 36 parts of C.I. Pigment Red 254 is admixed with an aqueous suspension of the compound (II) (4 parts). After the mixture has been stirred at room temperature for an hour, the suspension is filtered and the presscake is washed with water. The presscake is subsequently dried in a drying cabinet at 80° C. for 18 h and ground to powder in an IKA laboratory mill. This gives 38 parts of the inventive colorant composition 10 in the form of a red powder. Preparation of the millbase and of the bindered colorant dispersion, and also the performance tests, take place as in Example 1:

| | | Rel. | | | | Rel. |
|---|---|---|---|---|---|---|
| | | viscosity of | | | | contrast |
| | | millbase | | x = | Rel. Y | value |
| Ex. | Description | [%] | y = | (Ref.) | value | [%] |
| 10 | Composition 10 | 17 | 0.323 | 0.650 | +2.9 | 167 |
| C10 | C.I. Pigment | 100 | 0.312 | 0.650 | 0 | 100 |
| | Red 254 | | | | | |

The millbases of the inventive compositions have reduced viscosities as compared with the untreated pigments. In color filter application, the inventive examples exhibit increased brightness Y and improved contrast. They have steeper transmission curves.

Examples of the production of micronized colorant compositions by addition during salt kneading:

### EXAMPLE 11

In a laboratory kneader (Werner & Pfleiderer, 300 ml) 2.0 g of the compound (II) are kneaded with 18.0 g of commercial C.I. Pigment Yellow 138 with addition of 120 g of sodium chloride and 25 ml of diethylene glycol at a temperature of 80° C. for 18 h. The kneading dough is stirred in 0.9 l of 5% hydrochloric acid for two hours, after which the composition is filtered. The filter cake is treated again for 1 h with 0.9 l of demineralized water while stirring. After filtration, the colorant composition is washed with water and dried under reduced pressure.

The micronized colorant composition K11 obtained has a median particle size d₅₀=34 nm and a d₉₅ of 56 nm, with a standard deviation σ of 12 nm. Length to width ratio: 1.34:1.

### Comparative Example C11

A salt kneading operation is carried out where 20.0 g of commercial C.I. Pigment Yellow 138 are kneaded with 120 g of sodium chloride and 25 ml of diethylene glycol at a temperature of 80° C. for 18 h. The kneading dough is stirred in 0.9 l of 5% hydrochloric acid for two hours, after which the composition is filtered. The filter cake is treated again for 1 h with 0.9 l of demineralized water while stirring. After filtration, the pigment is washed with water and dried under reduced pressure. The pigment C11 obtained has a median particle size d₅₀=53 nm and a d₉₅ of 65 nm, with a standard deviation a of 12 nm. Length to width ratio: 1.30:1.

### EXAMPLE 12

The procedure of Example 11 is repeated, but using C.I. Pigment Green 36 instead of C.I. Pigment Yellow 138, to give the micronized colorant composition K12.

### Comparative Example C12

The procedure of Comparative Example C11 is repeated, but using C.I. Pigment Green 36 instead of C.I. Pigment Yellow 138.

### EXAMPLE 13

The procedure of Example 12 is repeated, but using compound (3) prepared according to Example 1 from WO2010000779 A1 instead of compound (II). This gives the micronized composition K13.

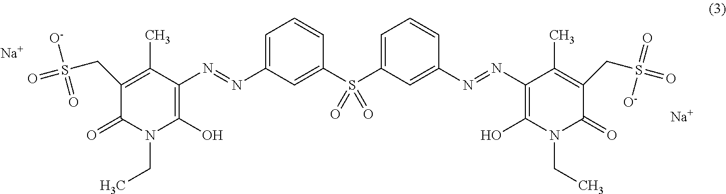 [SMILES: [Na+] ; CCn1c(O)c(/N=N/c2cccc(S(=O)(=O)c3cccc(/N=N/c4c(C)c(CS(=O)(=O)[O-])c(=O)n(CC)c4O)c3)c2)c(C)c(CS(=O)(=O)[O-])c1=O ; [Na+]]

### Comparative Example C13

The procedure of Comparative Example C12 is repeated.

### EXAMPLE 14

The procedure of Example 11 is repeated, but using C.I. Pigment Red 254 instead of C.I. Pigment Yellow 138, to give the micronized colorant composition K14.

### Comparative Example C14

The procedure of Comparative Example C11 is repeated, but using C.I. Pigment Red 254 instead of C.I. Pigment Yellow 138.

### EXAMPLE 15

The procedure of Example 11 is repeated, but using the DPP pigment according to the synthesis step from Example 1 in WO2009/049736A1 instead of C.I. Pigment Yellow 138, to give the micronized colorant composition K15.

### Comparative Example C15

The procedure of Comparative Example C11 is repeated, but using the DPP pigment according to the synthesis step from Example 1 in WO2009/049736A1 instead of C.I. Pigment Yellow 138.

### Performance Testing of Example 11-15 and C11-C15

The inventive micronized compositions are tested in analogy to Use Example 1. In place of the composition 1, however, the compositions as reported in Tables 3a and 3b below are used.

TABLE 3a
(reference to y values):

| | | | | Rel. | Rel. contrast |
|---|---|---|---|---|---|
| | | y = | | Y | value |
| Ex. | Description | (Ref.) | x = | value | [%] |
| 11 | Micronized composition K11 | 0.500 | 0.424 | +5.8 | 410 |
| C11 | Micronized C.I. PY138 | 0.500 | 0.431 | 0 | 100 |
| 12 | Micronized composition K12 | 0.440 | 0.270 | +9.2 | 115 |
| C12 | Micronized C.I. PG36 | 0.440 | 0.240 | 0 | 100 |
| 13 | Micronized composition K13 | 0.440 | 0.268 | +8.9 | 107 |
| C13 | Micronized C.I. PG36 | 0.440 | 0.240 | 0 | 100 |

The inventive micronized compositions K11-K13 exhibit higher contrast values and greater brightness than the respective analogous salt-kneaded pure pigments.

TABLE 3b
(reference to x values):

| | | | | Rel. | Rel. contrast |
|---|---|---|---|---|---|
| | | | x = | Y | value |
| Ex. | Description | y = | (Ref.) | value | [%] |
| 14 | Micronized composition K14 | 0.330 | 0.650 | +3.3 | 420 |
| C14 | Micronized PR254 | 0.318 | 0.650 | 0 | 100 |
| 15 | Micronized composition K15 | 0.335 | 0.650 | +1.5 | 854 |
| C15 | Micronized DPP pigment as | 0.331 | 0.650 | 0 | 100 |
| | per Example 1 from | | | | |
| | WO2009/049736A1 | | | | |

The inventive micronized compositions K14-K15 exhibit higher contrast values and higher brightnesses Y than the analogously salt-kneaded pure pigments.

1. A colorant composition comprising at least one compound of the formula (I) 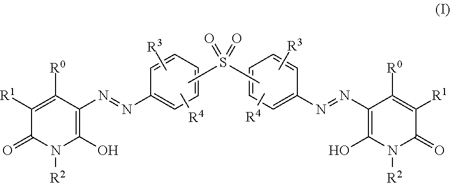
wherein
R⁰ is C₁-C₄ alkyl,
R¹ is H, C₁-C₄ alkyl, a sulfo group, —CO—NH—(C₁-C₄ alkyl), CN, or (C₁-C₄-alkylene)sulfo,
R² is H or C₁-C₄ alkyl,
R³ is H, a sulfo group, C₁-C₄ alkyl, or C₁-C₄ alkoxy,
R⁴ is H, C₁-C₄ alkyl, or C₁-C₄ alkoxy;
and at least one organic pigment.

2. The colorant composition as claimed in claim 1, wherein the compound of the formula (I) contains at least one sulfo group.

3. The colorant composition as claimed in claim 1, wherein
R⁰ is methyl,
R¹ is —CH₂-sulfo,
R² is ethyl,
R³ is H, a sulfo group, methyl, or methoxy, and
R⁴ is H, methyl, or methoxy.

4. The colorant composition as claimed in claim 1, wherein the compound of the formula (I) is a compound of the formula (Ia), 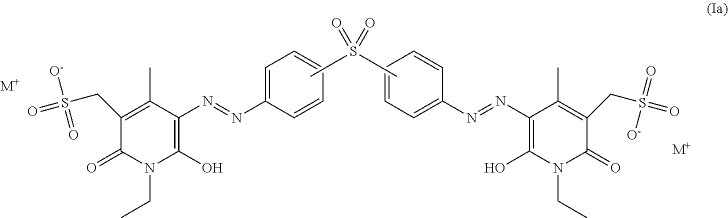
wherein M⁺ represents monovalent metal cations and H.

5. The colorant composition as claimed in claim 1, wherein the at least one organic pigment is selected from the group consisting of anthraquinone pigments, laked or unlaked azo pigments, anthanthrone pigments, benzimidazolone pigments, quinacridone pigments, quinophthalone pigments, diketopyrrolopyrrole pigments, dioxazine pigments, disazo condensation pigments, isoindolinone pigments, isoindoline pigments, metal complex pigments, perinone pigments, perylene pigments, phthalocyanine pigments, and triarylcarbonium pigments.

6. The colorant composition as claimed in claim 1, wherein the at least one organic pigment is
a yellow pigment selected from the group consisting of C.I. Pigment Yellow 138, 139, 150, 151, 155, 180, 213 and 214;
a red pigment selected from the group consisting of C.I. Pigment Red 122, 149, 166, 168, 177, 242, 254 and 264;
an orange pigment selected from the group consisting of C.I. Pigment Orange 34, 36, 38, 43, 62, 64, 68, 71, 72, 73, 74 and 81;
a green pigment selected from the group consisting of C.I. Pigment Green 7, 36 and 58;
a blue pigment selected from the group consisting of C.I. Pigment Blue 15:6, 15:3, 15:2, 15:1, 15 and 80;
a violet pigment from the group of C.I. Pigment Violet 19 and 23 or a mixture of pigments referenced hereinabove.

7. The colorant composition as claimed claim 1, wherein the at least one organic pigment is
a yellow pigment selected from the group consisting of C.I. Pigment Yellow 138, 139, and 150;
a red pigment selected from the group consisting of C.I. Pigment Red 254, 264, 242, and 177;
a green pigment selected from the group consisting of C.I. Pigment Green 7, 36, and 58;
a blue pigment from the group of Pigment Blue 15:6 and Pigment Blue 80 or a mixture of the pigments referenced hereinabove.

8. The colorant composition as claimed in claim 1, wherein the mixing ratio of compound of the formula (I) to organic pigment is from 1 to 99:99 to 1 parts by weight.

9. The colorant composition as claimed in claim 1, which is in the form of a millbase containing 0.01 to 45 wt % of the colorant composition comprising at least one compound of the formula (I) and at least one organic pigment, in dispersion in an organic solvent.

10. The colorant composition as claimed in claim 1, having the form of a binder-containing colorant dispersion containing 0.01 to 40 wt % of the colorant composition comprising at least one compound of the formula (I) and at least one organic pigment, in dispersion in at least one organic solvent, and comprising at least one polymeric binder and, optionally, further auxiliaries.

11. A method for producing a colorant composition as comprising the step of combining with one another the at least one compound of the formula (I) and at least one organic pigment 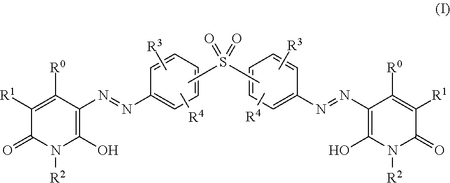
wherein
R⁰ is C₁-C₄ alkyl,
R¹ is H, C₁-C₄ alkyl, a sulfo group, —CO—NH—(C₁-C₄ alkyl), CN, or (C₁-C₄-alkylene)sulfo,
R² is H or C₁-C₄ alkyl,
R³ is H, a sulfo group, C₁-C₄ alkyl, or C₁-C₄ alkoxy, and
R⁴ is H, C₁-C₄ alkyl, or C₁-C₄ alkoxy.

12. color filter comprising a colorant composition as claimed in claim 1.

13. A color filter film comprising between 5 and 95 wt %, based on the total weight of the color filter film, a colorant composition as claimed in claim 1.

14. The colorant composition as claimed in claim 3, wherein R³ is H.

15. The colorant composition as claimed in claim 3, wherein R⁴ is H.
